(19) United States
(12) Patent Application Publication
(10) Pub. No.: US 2009/0243486 A1
(43) Pub. Date: Oct. 1, 2009

(54) Discharge Lamp

(75) Inventor: Anton Albrecht, Gaimersheim (DE)

Correspondence Address: FRISHAUF, HOLTZ, GOODMAN & CHICK, PC, 220 Fifth Avenue, 16TH Floor, NEW YORK, NY, 10001-7708, US

(73) Assignee: PATENT-TREUHAND-GESELLSCHAFT FUR elektrische Gluhlampen mbH, Munchen (DE)

(21) Appl. No.: 11/992,572

(22) PCT Filed: Sep. 26, 2006
(86) PCT No.: PCT/EP2006/066735

§ 371 Date: Mar. 25, 2008

(30) Foreign Application Priority Data
Sep. 28, 2005 (DE) 10 2005 046 483.1

(51) Int. Cl. H01J 61/36; H01J 9/00

(52) U.S. Cl. 313/625; 445/43

(57) ABSTRACT

Disclosed is a discharge lamp, particularly a high-pressure xenon or mercury discharge lamp, comprising a bulb that is provided with two diametrically arranged bulb shafts, each of which supports one electrode with an electrode holding rod and an electrode head. The electrode holding rods are gas-tightly fixed in final sections of the bulb shafts by means of a sealing process. According to the invention, the bulb shafts encompass at least two knobs for supporting the electrodes, which are in contact with the electrode holding rods in at least some sections.

### TECHNICAL FIELD

The invention relates to a discharge lamp in accordance with the precharacterizing clause of patent claim 1 and to a method for producing such a discharge lamp in accordance with the precharacterizing clause of patent claim 14.

### PRIOR ART

The discharge lamp according to the invention can in principle be used in a large number of different lamp types. The main application area of the discharge lamp, however, should be in the production of high-wattage xenon or mercury high-pressure discharge lamps.

Such a discharge lamp is known, for example, from DE 30 29 824 A1 by the Applicant. With this high-pressure discharge lamp with a base at two ends, the electrodes, which are arranged diametrically with respect to one another, are fixed in a gas-tight manner in the bulb shafts of the lamp vessel of the discharge lamp via a fuse seal. Such electrodes substantially comprise an electrode head, which is fixed on an electrode holding rod, for example via a soldered joint, or is designed to be integral with said electrode holding rod. Since the regions of the electrode fuse seals, in particular in the case of high-wattage high-pressure discharge lamps with a high electrode weight, are subjected to severe loads which can result in breakage of the lamp vessel in this region, it has proven to be necessary to support the electrodes in that bulb shaft end which faces the lamp bulb in each case by means of a supporting element, for example a supporting roll consisting of quartz glass, which is additionally fitted on the electrode holding rod, on the inner wall of the bulb shaft. For this purpose, a constriction is formed on the bulb shafts at the transition with the lamp bulb in such a way that the side which is remote from the discharge space of the lamp bulb has an inner sloping face, against which the supporting roll is brought into a bearing position. The supporting roll is arranged on the electrode holding rod in such a way that it is capable of being displaced in the longitudinal direction and is prestressed against the sloping faces of the lamp vessel via in each case one compression spring, which is arranged between the fuse seal and the supporting roll, with the result that the electrodes are supported with respect to the bulb shafts via the supporting rolls.

One disadvantage with such discharge lamps is that, as a result of the required compression springs and supporting rolls, their production is complicated and cost-intensive and they make it more difficult for the manufacturing process to be automated. A second disadvantage is the fact that, for example during transport of the discharge lamp, high forces occur between the supporting rolls and the bulb shaft inner wall, and these forces may result in abraded material and damage to the glass surface and, as a result, a reduced stability of the lamp in this region and even breakage of the lamp. Furthermore, the relatively small cross section of the exhaust path along the supporting rolls is disadvantageous, with the result that the flushing and exhaust operation of the lamp bulb is made more difficult.

### DESCRIPTION OF THE INVENTION

The invention is based on the object of providing a discharge lamp and a method for producing such a discharge lamp in which,

in comparison with conventional solutions, an improved electrode holding arrangement is made possible alongside minimum complexity in terms of apparatus.

This object is achieved as regards the discharge lamp by the combination of features in claim 1 and as regards the method for producing such a discharge lamp by the features of claim 14. Particularly advantageous embodiments of the invention are described in the dependent claims.

The discharge lamp according to the invention has a lamp bulb with two bulb shafts, which are arranged diametrically with respect to one another and each bear an electrode with an electrode holding rod and an electrode head, the electrode holding rods being fixed in a gas-tight manner in end sections of the bulb shafts by means of a fuse seal. According to the invention, the bulb shafts have at least two supporting knobs for supporting the electrodes, at least sections of which are brought to bear against the electrode holding rods. This solution makes it possible, in comparison with the prior art according to DE 30 29 824 A1, to substantially simplify the manufacture as a result of the omission of the two compression springs and supporting rolls and their fitting procedure, on account of the additional support of the electrodes via supporting knobs. Since no supporting rolls are used, no damage to the bulb shaft inner wall occurs during transport of the discharge lamp which could result in a reduced stability of the lamp in this region or even in breakage of the lamp. A further advantageous feature is the relatively large cross section of the exhaust path along the supporting knobs, with the result that the flushing and exhaust operation of the lamp bulb is simplified in accordance with the invention.

In accordance with a particularly preferred exemplary embodiment, the supporting knobs are formed by a wall region, which is deformed inwards towards the electrode holding rods and is brought to bear against the latter via supporting faces, of the bulb shafts. This means that the supporting knobs are designed to be integral with the bulb shafts and as a result can be introduced into the bulb shafts in a manner which is simple in terms of manufacturing technology and which can be automated easily.

It has proven to be particularly advantageous to introduce the supporting knobs into the bulb shafts by means of local heating of the bulb shaft to a deformation temperature and the formation of indentations in the glass with a tool, in particular a mandrel. As a result of the thermal deformation of the glass, the supporting face of the supporting knobs is matched to the contour of the electrode holding rods, with the result that a form-fitting holding arrangement of the electrodes is achieved, at least in sections.

Preferably, the supporting knobs are in the form of substantially cylindrical impressions. As a result of the cylindrical shaping, the supporting knobs can be introduced into the glass material in a manner which is advantageous in terms of manufacturing technology using a mandrel, and stress peaks in the region of the supporting knobs are avoided.

In the case of a preferred exemplary embodiment of the invention, the supporting knobs are introduced into the bulb shafts into the transition region between the bulb shafts and the lamp bulb. As a result of the supporting knobs, which are arranged spaced apart axially with respect to the fuse seal of the end sections of the electrode holding rod, a favorable lever and force ratio and, as a result, extensive strain-relief of the mechanically sensitive electrode fuse seal via the supporting knobs and a substantially improved lamp life are achieved.

The supporting knobs are introduced into the bulb shafts in such a way that the electrodes extend substantially along the lamp longitudinal axis.

In an exemplary embodiment, the bulb shafts each have two supporting knobs, which are arranged diametrically with respect to one another.

In accordance with a particularly preferred exemplary embodiment, in each case three supporting knobs are introduced into the bulb shafts. In this case, the supporting knobs are preferably arranged in such a way that they are offset with respect to one another through 120°, with the result that the electrode holding rods are positioned centrally in the bulb shafts and are supported in a stable manner.

The supporting knobs are designed in such a way that the electrode holding rods are mounted in the bulb shafts in such a way that they are capable of being displaced axially along the lamp longitudinal axis. As a result, a longitudinal displacement (movable bearing) of the electrodes is made possible as a result of the thermal expansion during lamp operation. In a preferred variant, the supporting knobs are furthermore designed in such a way that the electrode holding rods are mounted in the bulb shafts with radial play. This can be achieved, for example, by a defined penetration depth of the mandrel into the bulb shafts by means of CNC control of the manufacturing apparatus. Furthermore, the different coefficients of thermal expansion of glass and metal are used for a defined play since the metal of the electrodes on cooling shrinks to a greater extent than the lamp glass, with the result that, given a suitable selection of the type of glass, a defined play in the bearing arrangement is produced.

In an exemplary embodiment according to the invention, the bulb shafts are provided with a constriction in the region of the supporting knobs. As a result of the constriction, the penetration depth of the supporting knobs into the bulb shafts which is required in order for them to bear against the electrode holding rods is reduced and, as a result, the introduction of said supporting knobs is simplified.

In accordance with an exemplary embodiment according to the invention, the constriction has an approximately U-shaped cross section.

It has proven to be particularly advantageous to form the constriction by means of a shaping roller and then to introduce the supporting knobs into the constriction.

A method according to the invention for producing a discharge lamp takes place using the following steps:
a) introducing the electrodes into the bulb shafts;
b) fuse-sealing the electrode holding rods into end sections of the bulb shafts;
c) introducing at least two supporting knobs into the bulb shafts, and
d) flushing and filling the lamp bulb.

The quantity of heat required to form the supporting knobs is in this case preferably introduced into the glass material of the bulb shafts by means of gas-operated fuse-seal burners.

### BRIEF DESCRIPTION OF THE DRAWINGS

The invention will be explained in more detail below with reference to preferred exemplary embodiments. In the drawings:

FIG. 1 shows a schematic illustration of a discharge lamp according to the invention in accordance with an exemplary embodiment with three supporting knobs;

FIG. 2 shows a sectional illustration of the discharge lamp from FIG. 1;

FIG. 3 shows a schematic illustration of a discharge lamp according to the invention in accordance with an exemplary embodiment with two supporting knobs;

FIG. 4 shows a sectional illustration of the discharge lamp from FIG. 3;

FIG. 5 shows a schematic illustration of a discharge lamp according to the invention in accordance with an exemplary embodiment with a constriction;

FIG. 6 shows a sectional illustration of the discharge lamp from FIG. 5, and

FIG. 7 shows a sectional illustration of the discharge lamp from FIG. 1 during the manufacturing process.

### PREFERRED EMBODIMENT OF THE INVENTION

The invention will be explained below with reference to a xenon high-pressure discharge lamp, which is used, for example, in spotlights or in medical technology. As has already been mentioned at the outset, the discharge lamp according to the invention is in no way restricted to such lamp types, however.

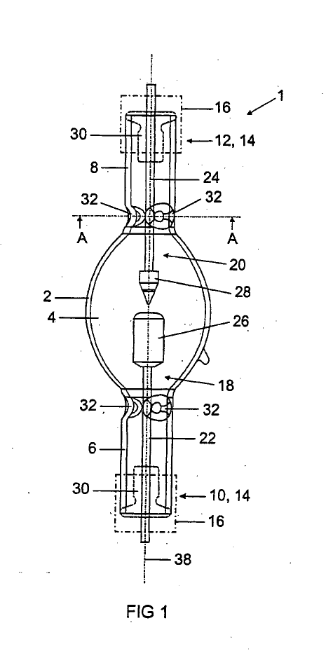

FIG. 1 shows a schematic illustration of a xenon high-pressure discharge lamp 1 with a base at two ends which uses short arc technology. Said lamp has a lamp bulb 2 consisting of quartz glass with an interior 4 and two diametrically arranged bulb shafts 6, 8, whose free end sections 10, 12 are each sealed off via a fuse seal 14 and are provided with a base sleeve 16. Two diametrically arranged electrodes 18, 20, between which a gas discharge is formed during lamp operation, protrude into the interior 4. In addition, an ionizable filling is enclosed in the interior 4 of the lamp bulb 2, which filling substantially consists of pure xenon gas. The electrodes 18, are each formed in two parts, comprising a rod-shaped electrode holding rod 22, 24 for supplying power and a discharge-side head electrode (anode) 26 or head-electrode (cathode) 28 soldered thereto. As shown in FIG. 1, one electrode head (cathode) 28 is in the form of a conical head cathode for the purpose of producing high temperatures in order to ensure defined attachment of the arc and a sufficient electron flow as a result of thermal emission and field emission (Richardson equation). The other electrode head in FIG. 1 which is the electrode head (anode) 26 is in the form of a barrel-shaped head anode which is subjected to a high thermal load, in which case the emitted power is improved by sufficient dimensioning of the electrode size. In order to hold the electrodes 18, 20 in the discharge vessel 2, they are inserted into holding elements 30 made of quartz glass, which are provided with an axially running through-hole for accommodating the electrode holding rods 22, 24 and are fuse-sealed to the bulb shafts 6, 8 and to the electrode holding rods 22, 24 in a gas-tight manner. The electrode holding rods 22, 24 of the electrodes 18, 20 are guided into the through-holes in such a way that they reach into the interior and bear the electrode heads 26 and 28 there. On the base side, the electrode holding rods 22, 24 are connected to the supply voltage for the purpose of making electrical contact with the electrode system via base pins or litz wires (not illustrated).

According to the invention, in order to additionally support the electrodes 18, 20, supporting knobs 32 are introduced into the bulb shaft 6, 8 in such a way that sections of them bear against the electrode holding rods 22, 24. As a result of the fact that the electrodes 18, 20 are supported via supporting knobs 32, the manufacture is substantially simplified by the emission of compression springs and supporting rolls required in the prior art and their fitting. Since no supporting rolls are used, furthermore no damage to the bulb shaft inner wall occurs during transport of the discharge lamp 1, which damage could result in a reduced stability of the lamp in this region or even in breakage of the lamp. A further advantage is the relatively large cross section of the exhaust path along the supporting knobs 32, with the result that the flushing and exhaust operation of the lamp bulb 2 is facilitated according to the invention. The supporting knobs 32 are introduced into the transition region between the bulb shafts 6, 8 and the lamp bulb 2, with the result that a favorable lever and force ratio is achieved as a result of the axial distance from the fuse seal 14 of the end section 10, 12 of the electrode holding rods 22, 24 and, as a result, extensive strain-relief of the mechanically sensitive electrode fuse seal 14 via the supporting knobs 32 and substantially improved lamp life are achieved.

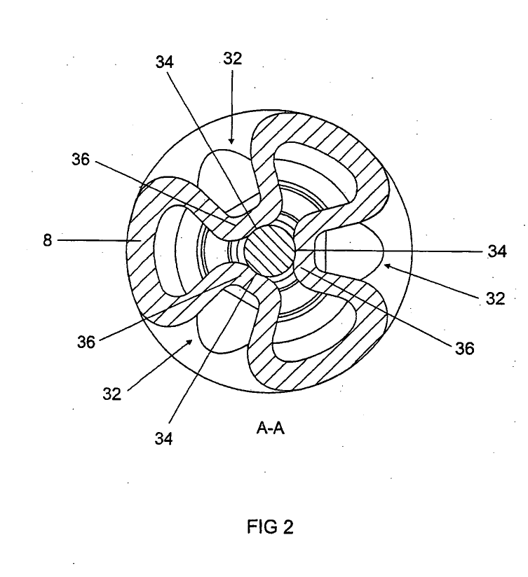

As shown in FIG. 2, which shows an enlarged illustration of the section A-A from FIG. 1, three supporting knobs 32, which are arranged in such a way that they are offset with respect to one another in each case through 120°, lie in a common tangential place and are formed by a wall region 36, which is deformed inwards, towards the electrode holding rods 22, 24 and is brought to bear against the latter via supporting faces 34, of the bulb shafts 6, 8, are introduced into the bulb shafts. The supporting knobs 32 are in this case introduced into the bulb shafts 6, 8 in such a way that the electrodes 18, 20 extend substantially along the longitudinal axis 38 (see FIG. 1) of the lamp 1. As a result of local heating of the bulb shafts 6, 8 to a deformation temperature and the formation of indentations in the glass using a mandrel in the form of substantially cylindrical impressions, the supporting knobs 32 have been introduced into the latter. As a result of the thermal deformation of the glass, the supporting face 34 of the supporting knobs 32 is matched to the contour of the electrode holding rods 22, 24, with the result that a form-fitting holding arrangement of the electrodes 18, 20 is achieved, in sections. Supporting knobs 32 are arranged in such a way that the electrode holding rods 22, 24 are mounted in the bulb shafts 6, 8 in such a way that they are capable of being displaced axially along the lamp longitudinal axis 38. As a result, a longitudinal displacement (movable bearing) of the electrodes 18, 20 is made possible as a result of the thermal expansion during lamp operation. The play is in this case achieved by a defined penetration depth of the mandrels into the bulb shafts 6, 8 by means of CNC control of the manufacturing apparatus or by the different coefficients of thermal expansion of glass and metal of the electrodes 18, 20, since the metal of the electrodes 18, 20 on cooling shrinks to a greater extent than the lamp glass, with the result that, given a suitable selection of the type of glass, a defined play in the bearing arrangement is produced.

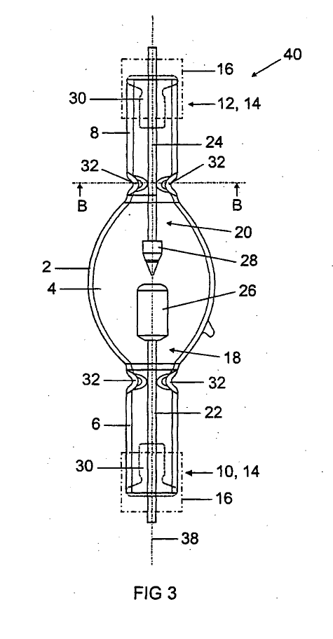

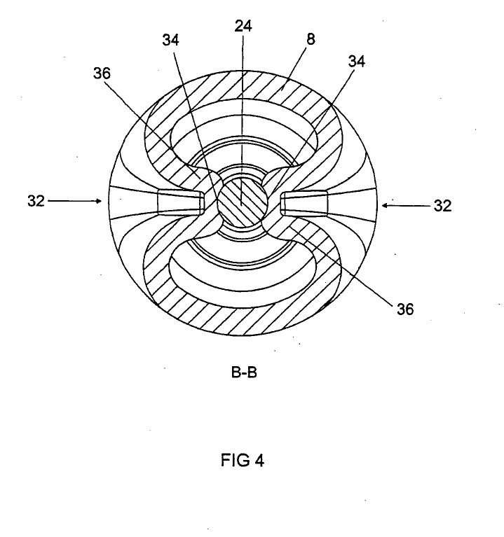

FIG. 3 illustrates a further exemplary embodiment of a xenon high-pressure discharge lamp 40, which differs from the exemplary embodiment explained in FIGS. 1 and 2 merely by virtue of the fact that in each case two supporting knobs 32, which are arranged diametrically with respect to one another, are introduced into the bulb shafts 6, 8. As shown in FIG. 4, which shows an enlarged illustration of the section B-B from FIG. 3, the supporting knobs 32, which are arranged diametrically with respect to one another, are approximately kidney-shaped and are brought into bearing contact with the electrode holding rods 22, 24 via the concave supporting face 34, with the result that said electrode holding rods 22, 24 are supported centrally in the bulb shafts 6, 8 in a form-fitting manner by means of the knobs 32.

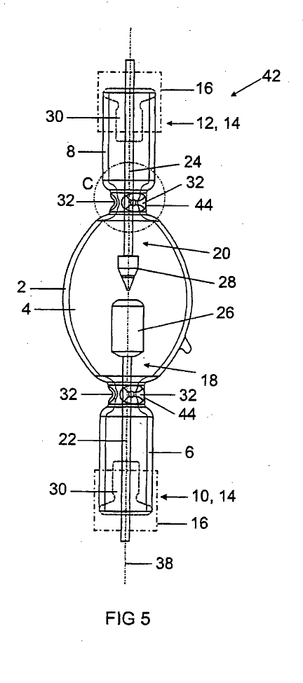

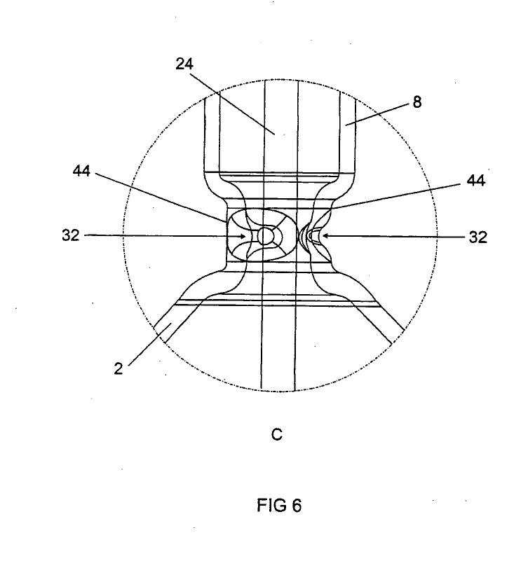

FIG. 5 shows an exemplary embodiment of a xenon high-pressure discharge lamp 42, which differs from the discharge lamp 1 explained in FIGS. 1 and 2 merely by virtue of the fact that the bulb shafts 6, 8 have been provided with a constriction 44 in the region of the supporting knobs 32. As shown in FIG. 6, which shows an enlarged illustration of the detail C from FIG. 5, the constrictions 44 are introduced into the bulb shafts 6, 8 between the lamp bulb 2 and the bulb shafts 6, 8 and have an approximately U-shaped cross section. It has proven to be particularly advantageous to form the constrictions 44 by means of a shaping roller and then to introduce the supporting knobs 32 into the constriction 44. As a result of the constriction 44, the penetration depth of the supporting knobs 32 into the bulb shafts 6, 8 which is required for them to bear against the electrode holding rods 22, 24 is reduced and, as a result, their introduction is simplified.

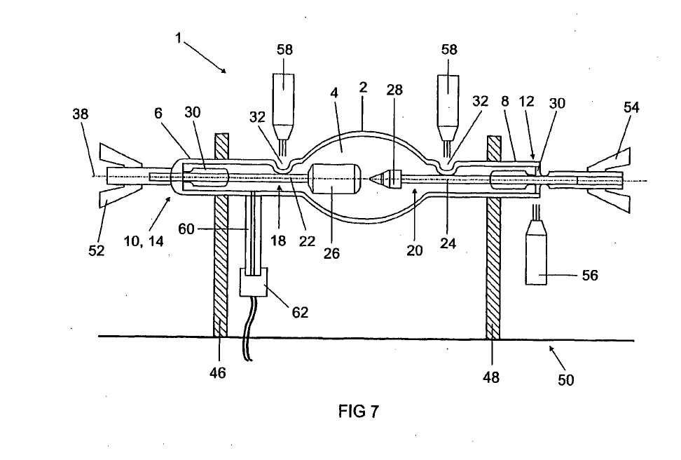

FIG. 7 shows a sectional illustration of the high-pressure discharge lamp 1 from FIG. 1 during the manufacturing process. Said lamp is inserted into two holding prisms 46, 48 of an apparatus 50 during the production via the bulb shafts 6, 8 and is fixed in position there. In order to adapt to different discharge lamp sizes, the holding prisms 46, 48 are designed to have an adjustable longitudinal distance.

The production of the high-pressure discharge lamp 1 will be explained by way of example in the text which follows with reference to the essential method steps. In a first working step, the electrodes 18, 20, which are inserted into holding elements 30 consisting of quartz glass, are introduced into the bulb shafts 6, 8 of the high-pressure discharge lamp 1, which is fixed in the apparatus 50, by means of collet chucks 52, 54 and adjusted there via an xy optical system (not illustrated). Then, the electrode holding rods 22, 24 are fuse-sealed in the end sections 10, 12 of the bulb shafts 6, 8 and the supporting knobs 32 are introduced. The heat input required for fuse-sealing the electrode holding rod 22, 24 is introduced into the glass material of the bulb shaft 6, 8 by means of gas-operated fuse-sealing burners 56 which rotate around the lamp longitudinal axis 38. The heat input required for forming the supporting knobs 32 is introduced into the glass material of the bulb shafts 6, 8 by means of gas-operated fuse-sealing burners 58 which can be displaced along the lamp longitudinal axis 38, the supporting knobs 32 being introduced into the bulb shafts 6, 8 after the local heating of the respective bulb shaft 6, 8 to a deformation temperature by means of forming indentations in the glass with a mandrel (not illustrated) of the fuse-sealing burners 58. In a final working step, the lamp bulb 2 is flushed via a flushing gas connection 62, which is connected to an exhaust tube 60, filled with high purity xenon gas and the exhaust tube 60 is fused off. In an alternative variant of a high-pressure discharge lamp 42 as shown in FIGS. 5 and 6, a constriction 44 is introduced into the bulb shafts 6, 8 in the region of the lamp bulb 2 before the supporting knobs 32 are introduced, with the result that the penetration depth of the supporting knobs 32 into the bulb shafts 6, 8 which is required for them to bear against the electrode holding rods 22, 24 is reduced and, as a result, their introduction is substantially simplified.

The discharge lamp 1, 40, 42 according to the invention is not restricted to the described number and arrangement of supporting knobs 32, but it is instead possible for more than two or three, for example four supporting knobs 32, which are each distributed around the circumference of the bulb shafts 6, 8, to be used. Furthermore, the knob technology can be used for all types of discharge lamps and bases known from the prior art. It is essential to the invention that the bulb shafts 6, 8 are provided with supporting knobs 32 in order to support the electrodes 18, 20, at least sections of which supporting knobs 32 are brought to bear against the electrode holding rods 22, 24.

The invention discloses a discharge lamp 1, 40, 42, in particular a xenon or mercury high-pressure discharge lamp, with a lamp bulb 2, which has two bulb shafts 6, 8, which are arranged diametrically with respect to one another and each bear an electrode 18, 20 with an electrode holding rod 22, 24 and an electrode head 26, 28, the electrode holding rods 22, 24 being fixed in a gas-tight manner in end sections 10, 12 of the bulb shafts 6, 8 by means of a fuse seal 14. According to the invention, the bulb shafts 6, 8 have at least two supporting knobs 32 for supporting the electrodes 18, 20, at least sections of which are brought to bear against the electrode holding rods 22, 24.

1. A discharge lamp (1, 40, 42), in particular a xenon or mercury high-pressure discharge lamp, with a lamp bulb (2), which has two bulb shafts (6, 8), which are arranged diametrically with respect to one another and each bear an electrode (18, 20) with an electrode holding rod (22, 24) and an electrode head (26, 28), the electrode holding rods (22, 24) being fixed in a gas-tight manner in end sections (10, 12) of the bulb shafts (6, 8) by means of a fuse seal (14), characterized in that the bulb shafts (6, 8) have at least two supporting knobs (32) for supporting the electrodes (18, 20), at least sections of which are brought to bear against the electrode holding rods (22, 24).

2. The discharge lamp as claimed in claim 1, the supporting knobs (32) being formed by a wall region (36), which is deformed inwards towards the electrode holding rods (22, 24) and is brought to bear against the latter via supporting faces (34), of the bulb shafts (6, 8).

3. The discharge lamp as claimed in claim 1, the supporting knobs (32) being introduced into the bulb shafts (6, 8) by means of local heating of the bulb shaft (6, 8) to a deformation temperature and the formation of indentations in the glass with a tool, in particular a mandrel.

4. The discharge lamp as claimed in claim 1, the supporting knobs (32) being in the form of substantially cylindrical impressions.

5. The discharge lamp as claimed in claim 1, the supporting knobs (32) being introduced into the transition region between the bulb shafts (6, 8) and the lamp bulb (2).

6. The discharge lamp as claimed in claim 1, the supporting knobs (32) being introduced into the bulb shafts (6, 8) in such a way that the electrodes (18, 20) extend substantially along the lamp longitudinal axis (38).

7. The discharge lamp as claimed in claim 1, the bulb shafts (6, 8) each having two supporting knobs (32), which are arranged diametrically with respect to one another.

8. The discharge lamp as claimed in claim 1, the bulb shafts (6, 8) each having three supporting knobs (32).

9. The discharge lamp as claimed in claim 8, the supporting knobs (32) being introduced into the bulb shafts (6, 8) in such a way that they are offset with respect to one another through 120°.

10. The discharge lamp as claimed in claim 1, the supporting knobs (32) being designed in such a way that the electrode holding rods (22, 24) are mounted in the bulb shafts (6, 8) in such a way that they are capable of being displaced axially along the lamp longitudinal axis (38).

11. The discharge lamp as claimed in claim 1, the supporting knobs (32) being designed in such a way that the electrode holding rods (22, 24) are mounted in the bulb shafts (6, 8) with radial play.

12. The discharge lamp as claimed in claim 1, the supporting knobs (32) being designed in such a way that the electrode holding rods (22, 24) are mounted in the bulb shafts (6, 8) with radial play. The discharge lamp as claimed in one of the preceding claims, the bulb shafts (6, 8) having a constriction (44) in the region of the supporting knobs (32).

13. The discharge lamp as claimed in claim 12, the constriction (44) having an approximately U-shaped cross section.

14. A method for producing a discharge lamp (1, 40, 42), in particular a xenon or mercury high-pressure discharge lamp, as claimed in claim 1, having the following steps:
a) introducing the electrodes (18, 20) into the bulb shafts (6, 8);
b) fuse-sealing the electrode holding rods (22, 24) into end sections (10, 12) of the bulb shafts (6, 8);
c) introducing at least two supporting knobs (32) into the bulb shafts (6, 8), and
d) flushing and filling the lamp bulb (2).

15. The method as claimed in claim 14, the supporting knobs (32) being introduced into the bulb shafts (6, 8) by means of local heating of the bulb shaft (6, 8) to a deformation temperature and the formation of indentations in the glass with a tool, in particular a mandrel.

16. The method as claimed in claim 14, the quantity of heat required for forming the supporting knobs (32) being introduced into the bulb shafts (6, 8) by means of gas-operated fuse-sealing burners (58).

17. The method as claimed in claim 14, a constriction (44) of the bulb shafts (6, 8) being formed by means of a shaping roller, into which constriction the supporting knobs (32) are then introduced.
